(19) United States
(12) Patent Application Publication
(10) Pub. No.: US 2025/0042503 A1
(43) Pub. Date: Feb. 6, 2025

(54) Method for Operating a Drive System of an at Least Temporarily Electrically Driven Bicycle

(71) Applicant: Robert Bosch GmbH, Stuttgart (DE)

(72) Inventors: Frederik Morlok, Wildberg Gueltlingen (DE); Julian Ophey, Renningen (DE); Sebastian Baumgaertner, Nuertingen-Raidwangen (DE); Ulrich Vollmer, Weilheim (DE)

(21) Appl. No.: 18/790,177

(22) Filed: Jul. 31, 2024

(30) Foreign Application Priority Data
Aug. 4, 2023 (DE) 10 2023 207 526.1

(51) Int. Cl. B62M 6/45; B62M 6/90

(52) U.S. Cl. CPC B62M 6/45; B62M 6/90

(57) ABSTRACT

A method for operating a drive system that includes a plurality of components of an at least temporarily electrically driven bicycle is disclosed. The method includes (i) providing at least one requirement of a first component and a requirement of a second component from the plurality of components of the drive system, (ii) comparing the requirement of the first component with the requirement of the second component with regard to a thermal load situation of the first component and the second component, and (iii) adjusting an operating behavior of the first component and/or the second component based on the comparison.

This application claims priority under 35 U.S.C. § 119 to patent application no. DE 10 2023 207 526.1, filed on Aug. 4, 2023 in Germany, the disclosure of which is incorporated herein by reference in its entirety.

### BACKGROUND

The present disclosure relates to a method for operating a drive system of an at least temporarily electrically driven bicycle and a drive system for an at least temporarily electrically driven bicycle and a bicycle.

Currently, there are a variety of different solutions to improve the driving dynamics of electrically driven bicycles or e-bikes. Due to the increasing variety of drive concepts in electrically driven bicycles, the need for robust and innovative control methods is continuously increasing.

### SUMMARY

The method according to the disclosure for operating a drive system comprising a plurality of components of an at least temporarily electrically driven bicycle with the features described herein has the advantage over the known method that thermal overloading of individual components can be avoided with the aid of system-based or macroscopic monitoring of an electric bicycle drive system, without significantly affecting the riding behavior or the riding dynamics of the electrically driven bicycle. In this case, an influence on the riding behavior or the riding dynamics can in particular take place such that it is hardly noticeable for a rider of a bicycle. Further preferably, it is possible to create a reproducible customer experience with the method, independent of external influences and design features of the electric drive system of the bicycle, by coordinating the operating behavior of the components of the drive system in a thermal load situation. The drive system can control itself independently and without user input such that no limitation of any of the components occurs. The riding dynamics for the user remain as unchanged as possible, independent of the thermal load situation of the individual components. A further advantage is that any reduction in power for component protection can be flexibly adjusted, such that there is as little influence as possible on the riding dynamics of the electrically driven bicycle.

According to the present disclosure, this is achieved in that the method for operating a drive system having a plurality of components of an at least temporarily electrically bicycle comprises the steps of:
providing at least one requirement of a first component and a requirement of a second component from the plurality of components of the drive system,
comparing the requirement of the first component with the requirement of the second component with regard to a thermal load situation of the first component and the second component,
adjusting an operating behavior of the first component and/or the second component based on the comparison.

In other words, the operating behavior of at least one component can be adjusted by way of a comparison of the plurality of components of the drive system. The operating behavior is adjusted in particular in such a way that a power output of a component of the plurality of components is at least temporarily reduced. The adjustment of the operating behavior can be a reduction of a power output of a battery unit, a reduction of the input power of an electric drive unit, a reduction of the torque of the electric drive unit, and/or the like. Furthermore, the method can be used to detect at least one property of a component from the plurality of components. A property such as a temperature value can, for example, be detected. Based on the comparison between the requirements of the two components, the operation behavior of the components can be adjusted.

For example, there is a requirement in the form of an increase in power output, such as a speed increase or a rotation torque increase of a user of the electrically driven cycle. For example, the drive system determines how long such an increased power output can be provided taking into account the thermal load situation of the individual components. Accordingly, the operating behavior of one or more components can be specifically adjusted to provide a reproducible and convenient riding experience independent of a thermal load situation of a single or more components. In particular, based on the comparison of the requirements of the components, the operating behavior of the components can be adjusted to one another in a coordinated manner.

The drive system includes a plurality of components. The first component is in particular a drive unit, the second component is in particular a battery unit. As a further component of the drive system, each component of a bicycle that comprises mechanical, electrical and/or electronic components and outputs a mechanical and/or electrical power during the operation of the drive system is considered. In a broad sense, a power output of a component is any output of a physical variable which is provided by the respective component and which represents its performance capability. An indication of a physical variable per unit of time can also represent the power output of a component. For example, a power output of the battery unit can be expressed by an electrical power or a discharging current. A power output of a drive unit can be, for example, expressed by a torque or a mechanical power. A power output of a component can also be an output signal, which is output by the component and used to control one or more other components. Examples of further components are: a user interface unit that is configured to display and/or control the drive system by the user of the bicycle; a gear shift device, a seat support device, a damping device, each of which are equipped with an actuator. The components of the drive system are connected to each other wirelessly or wired. For example, the battery unit can provide a voltage supply for the components, in particular for the drive unit.

The drive system further comprises a control unit which is configured to control the drive system. For example, the control unit can be configured as a standalone component that is connected wirelessly or wired to the plurality of components of the drive system. For example, the control unit can also be integrated into one of the components of the drive system. For example, the control unit can be integrated into the battery unit or into the drive unit. For example, the control unit can also be configured as a distributed system distributed over multiple components.

Preferred further developments of the disclosure are set forth below.

Further preferably, the method comprises the following step: adjusting the requirements based on a user indication.

An advantage of this embodiment is that the requirement of the first and/or the second component can be adjusted by way of the user input in order to be able to meet a riding requirement of the rider of the drive system of the electric bicycle, such as a speed increase or torque increase on the drive system. For example, the user input, which is indicative of a torque or speed increase, can be used to adjust or update the requirement of the first and/or the second component accordingly. This allows a new comparison between the adjusted requirements of the components with regard to their thermal load situation. With the renewed comparison, it can be necessary to adapt the operating behavior again if the adjusted requirements are selected such that the thermal load situation cannot reproduce them. This means, for example, that the power output in the form of torque can be reduced by a predetermined amount or dynamically for an increased torque requirement in order to be able to provide the driver with a pleasant driving experience despite the thermal load situation.

In addition, the method preferably comprises the step of: providing a property of the first component and/or the second component. A temperature variable, which describes the thermal state of the component, can in particular be considered as a property. A temperature variable can be, for example, a temperature or a temperature gradient.

Preferably, in the method, the adjustment of the operating behavior is configured to reduce a power output of the first component and/or the second component. The power output is reduced in particular by gradually, for example in stages or continuously, reducing the power output, in particular to avoid an abrupt stop of the power output from a comparatively high power output as much as possible. Gradually reducing the power output also has the advantage that power can be delivered over a longer period of time.

An advantage of the method is that the operating behavior of the drive system can be dynamically adjusted by way of the control loop between the property (e.g., temperature variable), requirement (e.g., power output) and the adjustment of the operating behavior, taking into account the thermal load situation of the components of the drive system. Thus, the riding dynamics of the electrically driven bicycle can be achieved without large changes or fluctuations.

In one configuration of the method, providing the requirement of the first component and/or the requirement of the second component comprises providing a power output of the first component and/or the second component. The provision of the power output can be a current power output or a future power output. A power output of a component is understood to mean an output of power of the component, wherein different physical variables can represent the power output of the respective component. For example, a power output of a drive unit can be understood to mean a torque or a speed, which can be provided by the drive unit. For example, a power output of a battery unit can be understood to mean a discharge current or a capacity that the battery unit can provide. In particular, a current power output of a component describes a power output that can currently be provided by the component. A future power output describes, in particular, a power output that is predicted for a later point in time based on an estimate, calculation, or the like.

Providing the requirement of the first component and/or the requirement of the second component can further comprise providing a time variable that specifies when adjusting the operating behavior of the first component and/or the second component is required due to a thermal load situation. The power output of the respective component is dependent on the thermal load situation of the respective component. If the thermal load situation of the respective component is comparatively high, the component can only provide a corresponding power output for a specific period of time. Accordingly, the power output must be reduced in order to avoid a thermal overload situation or a critical thermal state of the component. Taking into account the thermal load situation of the component, a time variable can be ascertained, which specifies when an adjustment of the operating behavior of the component is required. A time variable can be a time from which a reduction in the power output is required, or a time period within which the component can provide the current power output, or a time period within which the component can provide a reduced power output. Such a time variable can be determined, for example, from a temperature and/or a temperature gradient of the component and a current and/or future power output of the component and, if necessary, further parameters. The time variable can in particular be determined in a control unit.

Preferably, comparing the requirement of the first component with the requirement of the second component comprises comparing the time variable of the first component with the time variable of the second component. In order to compare the first component and the second component with regard to a thermal load situation, the time variables of the two components are compared with each other, which specify when an adjustment of the operating behavior of the component is required. The two time variables can in particular be compared in one control unit.

In particular, comparing comprises determining a critical component, wherein the critical component is considered to be the one of the two components whose time variable is less than the time variable of the other components. The one of the two components with the smaller time variable is more thermally loaded than the other component and requires an adjustment of the operating behavior earlier than the other components. The critical component can in particular be determined in a control unit.

Furthermore, comparing can preferably also comprise determining a reduced power output of the critical component. The reduced power output is selected such that an adjusted operating behavior based on the reduced power output results in the time variable of the critical component being increased. This has the advantage that the operating behavior of the first and the second component is at least partially adjusted with regard to the thermal load situation: The difference between the time variable of the critical component and the other component is reduced.

Preferably, the next step is to adjust the operating behavior of the critical component based on the reduced power output. This means the critical component can provide a power output over a longer period of time, albeit at a lower level. The operating behavior of the two components can thus be at least partially adjusted to one another.

An advantage of this embodiment is that in the event of a thermal load situation of the drive system, it can be determined which of the components should first have a power reduction. Thus, the operating behavior of the component which has the shortest time period can be changed such that the entire drive system has a comparable operating behavior, regardless of which component should first have a power reduction. In particular, the operating behavior of the drive system as a whole is changed such that the riding experience for a user does not show any noticeable changes.

For example, the drive system comprises an electrical battery unit, as well as an electrical drive unit. The battery unit can provide a power output in the form of a discharge current and the drive unit can provide a torque as the power output. For example, the thermal load situation of the drive unit can be such that the operating behavior must be adjusted in five minutes. For example, the thermal load situation of the battery unit can be such that the operating behavior of the battery unit must be adjusted in three minutes. The battery unit can thus be identified as the component having the lowest time variable, such as three minutes in this example. Furthermore, the power output or the operating behavior of the battery unit can be adjusted by reducing it so that the time period is increased. The operating behavior can be adjusted such that the power output takes place in a range that has little or no influence on the riding dynamics of the electric bicycle. The reduction of the power output can be changed such that the battery unit also requires five minutes to adjust the operating behavior, so that the adjustment for the battery unit and the drive unit takes place simultaneously.

In one configuration of the method, the operating behavior is adjusted by reducing the power output such that a convenient power output of the first component and/or the second component is enabled. A convenient power output is to be understood as a power output that can be provided by the respective component by maintaining predetermined limit values for the power output of the respective component. These predetermined limit values are defined by the system such that they enable a convenient driving behavior, even if a thermal load situation occurs in at least one of the components and an adjustment of the operating behavior due to the thermal load situation is required. A convenient power output is controlled by the predetermined limit values such that the adjustment of the operating behavior is substantially not discernible to the user of the bicycle. The user of the bicycle does not notice the reduction in power output because it is occurring gradually. In particular, a convenient power output is a power output that prevents an abrupt reduction in the power output or a steep reduction with a high reduction of the power output per time unit, or even an abrupt shutdown. A convenient power output is also achieved by matching the operating behavior of the components to each other.

In a further configuration of the method, the following step is provided: comparing the requirement of the first component and/or the second component to a predetermined limit value. If, when comparing the requirement, it is established that the requirement of the first and/or the second component, preferably the requirement of both components, does not exceed the predetermined limit value, then the drive system is initially operated further without adjusting the operating behavior or any other intervention in the drive system. However, if it is established during the comparison of the requirements with the predetermined limit value that the first and/or the second component exceeds the predetermined limit value with its requirement, the following step is carried out next: comparing the requirement of the first component with the requirement of the second component with regard to a thermal load situation of the first component and the second component. This method step has already been explained in more detail above. An intervention in the drive system by comparing or matching the thermal load situation of the components linked in the drive system therefore takes place above a predetermined limit value in particular. Below the predetermined limit value, there is no unnecessary intervention due to a determined thermal load situation.

The predetermined limit value can in particular be defined by the fact that the requirement of the first component and/or the second component below the limit value enables a stable power output of the first component and/or the second component. A stable power output of a component is in particular a power output for which no adjustment of the operating behavior of the component is required due to a thermal load situation. If the power output of a component is stable, the component can provide the power output without reaching a critical thermal state that would require adjustment of the operating behavior of the component. Below a limit value defined in this way, the components are in a temperature range that is thermally non-critical.

In this configuration of the method, the requirements of the components in the system are only compared or matched if the operating behavior of at least one of the components is about to be adjusted with regard to its thermal load situation. If the requirements of both or all components are below the predetermined limit value, both components are in a range of stable power output in which no adjustment of the operating behavior is required due to a thermal stress situation.

The limit value up to which there is no intervention of the drive system by comparing or matching the requirements of the components can alternatively be defined on the basis of criteria other than the criteria for a stable power output.

A further aspect of the disclosure relates to a drive system for at least one temporarily electrically driven bicycle. The control unit is configured to perform the method according to the disclosure. The control unit is configured to provide at least one requirement of a first component and a requirement of a second component from a plurality of components of the drive system. The control unit is also configured to compare the requirement of the first component with the requirement of the second component from the plurality of components of the bicycle with regard to a thermal load. The control unit is further configured to provide an operating behavior of the first component and/or the second component based on the comparison.

An advantage of the drive system according to the disclosure is that the power output, such as the torque of the component, can be reduced by way of the control unit if this is required in order to keep the riding behavior of the electrically driven bicycle as constant as possible. The drive system can in particular comprise a drive unit as a first component and a battery unit as a second component.

A further aspect of the disclosure relates to an at least temporarily electrically operated bicycle comprising a drive system having a plurality of components and a control unit configured to perform steps of the method as described above and below.

### BRIEF DESCRIPTION OF THE DRAWINGS

Embodiment examples of the disclosure are explained in detail below with reference to the accompanying drawings. The drawing are briefly described below.

FIG. 1 shows a logical linking of portions of the method, according to one embodiment,

FIG. 2 shows a flow chart illustrating the steps of the method according to one embodiment,

FIG. 3 shows a flow chart illustrating the steps of the method according to one embodiment,

FIG. 4 shows a vehicle according to one embodiment,

FIG. 5 shows a drive system according to one embodiment.

### DETAILED DESCRIPTION

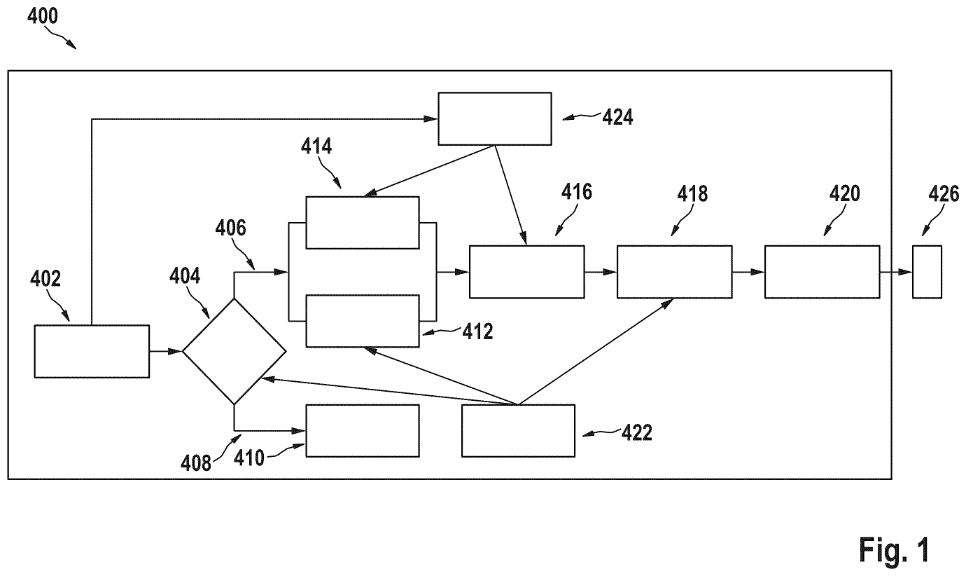

FIG. 1 shows an illustration for understanding the logic to avoid power reductions during the operation of a bicycle according to one embodiment. The logic 400 includes a plurality of individual steps. The logic 400 comprises predicting a future torque or electrical power output requirement of the driver 402. Depending on the driver's power requirement 402, a comparison 404 between the power requirement 402 and a limit value can be made. If the limit value in the comparison 404 is not exceeded or the requirement 402 can be met, no further steps are considered 410. If the requirement 402 cannot be met 406 in the comparison 404, a plurality of steps can be initiated. In particular, these steps can be a calculation of a time period 414 until power minimization can take place. Furthermore, one of these steps can be calculating a soft or convenient power minimization 412. A further step can be to calculate a time for initiating power minimization 416. A further step can be to calculate the power or torque limits 418. A further step can be the output of the limitation or power minimization 420. A further can be the transfer or monitoring of the limit 426. The interface 422 can provide information for the steps 404, 412 and 418. Based on the data from the interface 422, a stable power output or torque can be predicted.

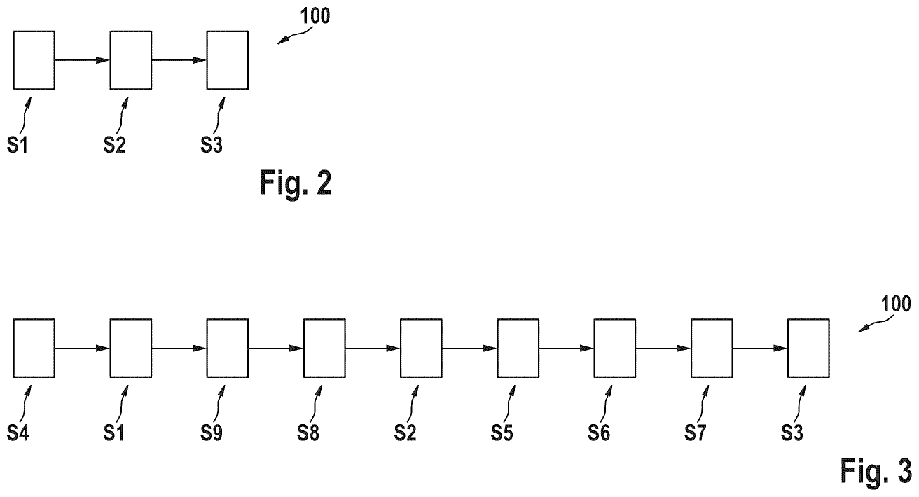

FIG. 2 shows a flowchart illustrating steps of the method 100 according to the disclosure. The method 100 comprises the step of providing S1 at least one requirement of a first component 202 and a requirement of a second component 204 from a plurality of components 205 of the drive system 200 of the bicycle 300. Furthermore, the method 100 has the step of comparing S2 the requirement of the first component 202 with the requirement of the second component 204 with regard to a thermal load situation. The method 100 further comprises the step of adjusting S3 an operating behavior of the first component 202 and/or the second component 204 based on the comparison.

FIG. 3 shows a flow chart illustrating the steps of the method 100 according to one embodiment. The method 100 comprises steps S1 to S3, as already explained in FIG. 2. The step of providing S1 the requirements of the first component 202 and the second component 204 comprises, in particular, providing a current or future power output of the first and the second component 202, 204, and providing a time variable of the two components 202, 204, which specifies when an adjustment of the operating behavior is required due to a thermal stress situation. Furthermore, the method 100 comprises the step of adjusting S4 the requirement based on a user input. Furthermore, the method 100 comprises the step of providing S9 a property, for example a temperature variable, of the first and/or the second component 202, 204. In addition, the method 100 comprises the step of comparing S5 the time variable of the first component 202 with the time variable of the second component 204 as well as ascertaining S6 a critical component. The one of the two components 202, 204 whose time variable is smaller than the time variable of the other component is categorized as the critical component. The critical component is thus the one of the two components 202, 204 that requires an earlier adjustment of the operating behavior due to its thermal load situation. Furthermore, the method 100 comprises the step of determining S7 a reduced power output of the critical component, wherein the reduced power output results in the time variable of the critical component being increased. The reduced power output determined is applied in the step of adjusting S3 the operating behavior of the critical component. This ensures a pleasant riding experience for the user of the bicycle. In the variant shown here, the method also comprises a step S8 of comparing the requirement of the first component 202 and the second component 204 with a predetermined limit value, which defines that the power output of the first component 202 and/or the second component 204 below the limit value enables a stable power output of the components 202, 204. Below the limit value, the components 202, 204 are in a temperature range that is thermally non-critical for the components 202, 204. Adjusting the operating behavior, in particular lowering the power output, due to a thermal load situation is not required in this range.

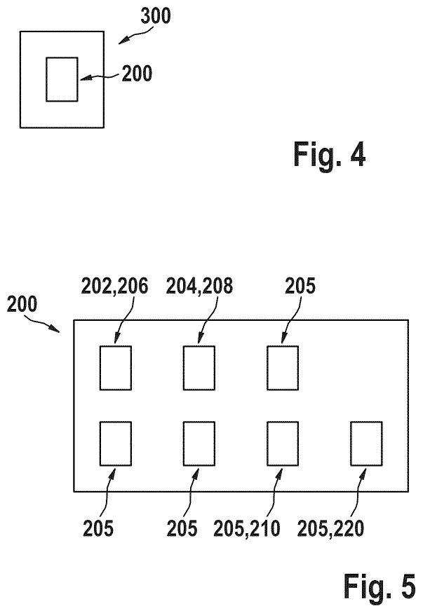

FIG. 4 schematically illustrates an at least temporarily electrically operated bicycle 300 having a drive system 200 according to one embodiment. The drive system 200 is configured to perform the steps of method 100 as described above.

FIG. 5 shows the drive system 200 according to one embodiment. The drive system 200 comprises a plurality of components 205. A first component 202 is formed by a drive unit 206. A second component 204 is formed by a battery unit 208. A further component 205 is formed by a user interface unit 210. Furthermore, the drive system 200 comprises a control unit 220. In the embodiment according to FIG. 5, the control unit 220 is configured as a standalone further component 205. In the embodiment according to FIG. 5, three further components 205 are provided, which are not described in further detail. Examples of such further components 205 can be: a gear shift device, a saddle support device, a damping device. The control unit 220 is configured to perform the steps of method 100 as described above.

What is claimed is:

1. A method for operating a drive system that includes a plurality of components of an at least temporarily electrically driven bicycle, comprising:
providing at least one requirement of a first component and a requirement of a second component from the plurality of components of the drive system;
comparing the requirement of the first component with the requirement of the second component with regard to a thermal load situation of the first component and the second component; and
adjusting an operating behavior of the first component and/or the second component based on the comparison.

2. The method according to claim 1, further comprising adjusting the requirement based on a user input.

3. The method according to claim 1, further comprising providing a property of the first component and/or the second component.

4. The method according to claim 1, wherein adjusting the operating behavior includes reducing a power output of the first component and/or the second component.

5. The method according to claim 1, wherein providing the requirement of the first component and/or the requirement of the second component includes providing a current or future power output of the first component and/or the second component.

6. The method according to claim 1, wherein providing the requirement of the first component and/or the requirement of the second component includes providing a time variable that specifies when adjusting the operating behavior of the first component and/or the second component is required due to a thermal load situation.

7. The method according to claim 6, wherein comparing the requirement of the first component with the requirement of the second component includes comparing the time variable of the first component with the time variable of the second component.

8. The method according to claim 7, wherein:
comparing includes ascertaining a critical component, and
the critical component is considered to be the one of the two components whose time variable is less than the time variable of the other component.

9. The method according to claim 7, wherein:
comparing includes determining a reduced power output of the critical component, and
the reduced power output results in the time variable of the critical component being increased.

10. The method according to claim 9, wherein adjusting the operating behavior of the critical component is based on the reduced power output.

11. The method according to claim 8, wherein adjusting the operating behavior includes reducing the power output of the critical component such that the time variable of the critical component is increased.

12. The method according to claim 1, wherein adjusting the operating behavior includes reducing the power output such that a shutdown of the first component and/or the second component is avoided.

13. The method according to claim 1, wherein:
adjusting the operating behavior includes reducing the power output such that a convenient power output of the first component units and/or the second component is enabled, and
the convenient power output is defined by maintaining predetermined limit values for the power output of the respective component.

14. The method according to claim 1, further comprising comparing the requirement of the first component and/or the second component with a predetermined threshold value, wherein comparing the requirement of the first component with the requirement of the second component with regard to a thermal load situation of the first component and the second component is performed when the predetermined limit value is exceeded.

15. The method according to claim 14, wherein:
the predetermined limit value is defined in that the power output of the first component and/or the second component below the limit value enables a stable power output of the first component and/or the second component, and
the stable power output is defined in that an adjustment of the operating behavior is not required due to a thermal load situation.

16. A drive system for an at least temporarily electrically driven bicycle, comprising:
a plurality of components; and
a control unit which is configured to provide at least one requirement of a first component and a requirement of a second component,
wherein the control unit is further configured to compare the requirement of the first component with the requirement of the second component with regard to a thermal load situation of the first component and the second component, and
wherein the control unit is additionally configured to adjust an operating behavior of the first component and/or the second component.

17. The drive system according to claim 16, wherein the first component is a drive unit and the second component is a battery unit.

18. A bicycle having a driven system according to claim 16.

19. The method according to claim 3, wherein the property includes a temperature variable of the first component and/or the second component.
